(19) United States
(12) Patent Application Publication
(10) Pub. No.: US 2006/0268287 A1
(43) Pub. Date: Nov. 30, 2006

(54) Automated promotion of monochrome jobs for HLC production printers

(75) Inventor: David C. Robinson, Penfield, NY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: XEROX CORPORATION

(21) Appl. No.: 11/136,821

(22) Filed: May 25, 2005

(51) Int. Cl. G06F 3/12

(52) U.S. Cl. 358/1.1

(57) ABSTRACT

Methods and apparatus are provided for automated promotion of monochrome jobs for highlight color (HLC) production printers in favor of color print jobs when it is determined that the color print jobs cannot be printed in an originally called-for marking material. First print jobs having a color content and second print jobs not having a color content are stored in a print queue. When an inability of the printing apparatus to print hard copy documents having a color content is detected, print jobs not having a color content are selected for printing from the print queue. Jobs are processed to determine color content including use of a raster image processing (RIP) at a low level resolution. A process in a print queue management system is provided for detecting an inability of the printing apparatus to print hard copy documents having a color content and for promoting print jobs without a color content for printing.

### BACKGROUND

The present application relates generally to methods and apparatus for automated commercial printing of documents and, more particularly, to methods and apparatus for printing selected first print jobs automatically in favor of second print jobs when it is determined that the second print jobs cannot be printed in an originally called-for marking material. That is, the first print jobs are promoted or advanced in a print queue for printing ahead in time over the second print jobs. The subject methods and apparatus are particularly useful in automated promotion of monochrome jobs for highlight color (HLC) production printers and will be described with reference thereto. However, it is to be appreciated that the invention is useful in many other areas and applications where color production printing is used.

A process referred to as “highlight color imaging” has been accomplished by employing basic xerographic techniques. The concept of tri-level, highlight color xerography is described in U.S. Pat. No. 4,078,929. That patent discloses the use of tri-level xerography as a means to achieve single-pass highlight color imaging. As disclosed therein, a charge pattern is developed with toner particles of first and second colors. The toner particles of one of the colors are positively charged and the toner particles of the other color are negatively charged. In one embodiment, the toner particles are supplied by a developer which comprises a mixture of triboelectricially relatively positive and relatively negative carrier beads. In another embodiment, the toner particles are presented to the charge pattern using a pair of magnetic brushes, each brush supplying atoner of one color and one charge. In yet another embodiment, the development systems are biased to approximately the background voltage. Such biasing results in a developed image of improved color sharpness.

By proper relation of operational control voltages and toner types, a highlight color printing machine can operate in one of three operational modes, namely “highlight color”, “monochrome-color” or “monochrome-black”. Additionally, the toner or marking material used to generate highlight or monochrome color can assume one of a wide variety of colors. Preferably, a print job is executed on the highlight color printing machine by providing a program indicating selections for color printing mode and marking material color. In executing a print job, however, it is not always possible, from a user's point of view, to control either the mode in which the machine is operated or the color in which the machine prints. For example, when the printing machine runs out of the color toner called for by the print job program, typically, the print job is faulted so that the program submitter must either provide a new toner selection consistent with what is available at the printing machine or wait until the programmed color toner is available. In another example, various sub-components of the printing machine may malfunction or otherwise become inoperative thus preventing printing of the color toner called for by the print job program. Typically, in those instances, the print job is faulted and the printing machine suspends operations until a machine operator can tend to the inoperative or malfunctioning portions of the HLC printer.

Many HLC commercial printing operations are characterized as “lights-out” facilities because many large print jobs are processed essentially continuously with little or no human intervention. Bulk printing machines are typically connected to a central job dispatcher through an electronic network. In those type applications, a fault condition causing a color printing delay which may arise due to failure of a xerographic sub-system, an inadequate supply of color toner, an improper color, or other reasons, can result in significant delays and potentially massive commercial losses.

U.S. Pat. No. 5,524,181 proposes a solution when the particular color used to provide the emphasis is of little importance. In that patent, a decision is made to substitute colors for jobs in a highlight color printing system, rather than faulting the jobs and thus temporarily suspending commercial operation. Essentially, the solution proposed there substitutes a requested marking material with an available marking material when the requested marking material is not available. Alternatively, the system taught there switches the printing machine from an unavailable color printing mode to an available color printing mode.

However, many customers of HLC printing operations are sensitive to the particular color used in printing their documents. Users are often intent on using a particular highlight color or shade to emphasize certain portions of their documents. One example is a corporate logo or trademark on letterhead or printed on bill forms. In such cases, a system for substituting colors for jobs in a highlight color printing system is not an acceptable solution.

Accordingly, there is need in the art for a method and system for print queue management for automated promotion of monochrome jobs when one or more print jobs with a color content cannot be accommodated. Particularly, there is a need in the art for a method and system for print queue management in HLC production printers for automated promotion of monochrome jobs when one or more HLC print jobs cannot be processed.

### CROSS REFERENCE TO RELATED PATENTS AND APPLICATIONS

The following applications, the disclosures of each being totally incorporated herein by reference are mentioned:

U.S. Provisional Application Ser. No. 60/631,651 (Attorney Docket No. 20031830-US-PSP), filed Nov. 30, 2004, entitled “TIGHTLY INTEGRATED PARALLEL PRINTING ARCHITECTURE MAKING USE OF COMBINED COLOR AND MONOCHROME ENGINES,” by David G. Anderson, et al.;

U.S. Provisional Patent Application Ser. No. 60/631,918 (Attorney Docket No. 20031867-US-PSP), filed Nov. 30, 2004, entitled “PRINTING SYSTEM WITH MULTIPLE OPERATIONS FOR FINAL APPEARANCE AND PERMANENCE,” by David G. Anderson et al.;

U.S. Provisional Patent Application Ser. No. 60/631,921 (Attorney Docket No. 20031867Q-US-PSP), filed Nov. 30, 2004, entitled “PRINTING SYSTEM WITH MULTIPLE OPERATIONS FOR FINAL APPEARANCE AND PERMANENCE,” by David G. Anderson et al.;

U.S. application Ser. No. 10/924,458 (Attorney Docket A3548-US-NP), filed Aug. 23, 2004, entitled “PRINT SEQUENCE SCHEDULING FOR RELIABILITY,” by Robert M. Lofthus, et al.;

U.S. application Ser. No. 10/933,556 (Attorney Docket No. A3405-US-NP), filed Sep. 3, 2004, entitled “SUBSTRATE INVERTER SYSTEMS AND METHODS,” by Stan A. Spencer, et al.;

U.S. application Ser. No. 10/953,953 (Attorney Docket No. A3546-US-NP), filed Sep. 29, 2004, entitled “CUSTOMIZED SET POINT CONTROL FOR OUTPUT STABILITY IN A TIPP ARCHITECTURE,” by Charles A. Radulski et al.;

U.S. application Ser. No. 11/000,168 (Attorney Docket No. 20021985-US-NP), filed Nov. 30, 2004, entitled “ADDRESSABLE FUSING AND HEATING METHODS AND APPARATUS,” by David K. Biegelsen, et al.;

U.S. application Ser. No. 11/001,890 (Attorney Docket A2423-US-DIV), filed Dec. 2, 2004, entitled “HIGH RATE PRINT MERGING AND FINISHING SYSTEM FOR PARALLEL PRINTING,” by Robert M. Lofthus, et al.;

U.S. application Ser. No. 11/002,528 (Attorney Docket A2423-US-DIV1), filed Dec. 2, 2004, entitled “HIGH RATE PRINT MERGING AND FINISHING SYSTEM FOR PARALLEL PRINTING,” by Robert M. Lofthus, et al.;

U.S. application Ser. No. 11/069,020 (Attorney Docket 20040744-US-NP), filed Feb. 28, 2004, entitled “PRINTING SYSTEMS,” by Robert M. Lofthus, et al.;

U.S. application Ser. No. 11/102,899 (Attorney Docket 20041209-US-NP), filed Apr. 8, 2005, entitled “SYNCHRONIZATION IN A DISTRIBUTED SYSTEM,” by Lara S. Crawford, et al.;

U.S. application Ser. No. 11/102,910 (Attorney Docket 20041210-US-NP), filed Apr. 8, 2005, entitled “COORDINATION IN A DISTRIBUTED SYSTEM,” by Lara S. Crawford, et al.;

U.S. application Ser. No. 11/102,355 (Attorney Docket 20041213-US-NP), filed Apr. 8, 2005, entitled “COMMUNICATION IN A DISTRIBUTED SYSTEM,” by Markus P. J. Fromherz, et al.;

U.S. application Ser. No. 11/102,332 (Attorney Docket 20041214-US-NP), filed Apr. 8, 2005, entitled “ON-THE-FLY STATE SYNCHRONIZATION IN A DISTRIBUTED SYSTEM,” by Haitham A. Hindi; and,

U.S. application Ser. No. 11/122,420 (Attorney Docket 20041149-US-NP), filed May 5, 2005, entitled “PRINTING SYSTEM AND SCHEDULING METHOD,” by Austin L. Richards.

### BRIEF DESCRIPTION

In accordance with one aspect of the disclosed embodiment of the present invention, there is provided a method of print queue management in an HLC printing apparatus comprising storing a plurality of first and second print jobs in a print queue of the HLC printing apparatus. The first print jobs have a color content and the second print jobs do not have a color content. The method further includes detecting, in the HLC printing apparatus, an inability of the printing apparatus to print hard copy documents having a color content. When the inability of the printing apparatus to print the hard color copy documents is detected, the method selects for printing from the print queue only from the plurality of second print jobs not having the color content.

### BRIEF DESCRIPTION OF THE DRAWINGS

FIG. 1 is a schematic, block diagrammatic view of an electronic printing machine system of an embodiment of the present invention;

FIG. 2 is a schematic, block diagrammatic view of a generic highlight color print queue in the printing machine of FIG. 1;

FIG. 3 is a flow diagram illustrating a first technique for automated promotion of monochrome jobs for the printer system of FIG. 1 in accordance with an embodiment of the invention; and

FIG. 4 is a flow diagram illustrating a second technique for automated promotion of monochrome jobs for the printer system of FIG. 1 in accordance with another embodiment of the invention.

### DETAILED DESCRIPTION

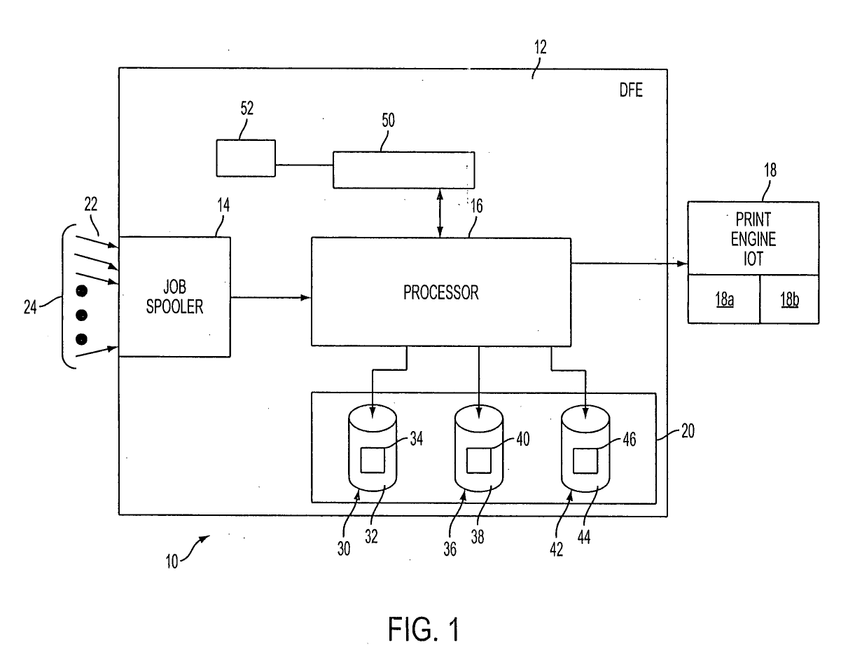

With reference first to FIG. 1, a print system 10 formed in accordance with an embodiment of the present invention is illustrated in schematic, block diagrammatic view. As shown, the print system 10 preferably includes a digital front end (DFE) 12 operable in an associated network (not shown), a job spooler 14, a processor 16, a highlight color print engine 18, and a print queue bank 20.

As indicated at 22, the job spooler 14 of the print system 10 is adapted to receive a plurality of print jobs 24 into the printer 12 for storage into the print queue bank 20 and, ultimately, for reproduction into hard copy format by the color print engine (IOT) 18. In the embodiment illustrated, the processor 16 performs all of the necessary control functions in the DFE 12 as well as handling the manipulation of storage of the digital images received as the plurality of print jobs 24 into the print queue bank 20 and the assignment of print jobs from the print queue bank for printing onto hard copy format by the IOT.

It is to be appreciated that the print jobs 24 routed to the print system 10 from an associated network (not shown) can take on any form within the capability realm of the print system. More particularly, the print jobs 24 can be monochrome-black images, monochrome-color images, or highlight color images. To that end, and to help facilitate explanation of the preferred embodiments, the print queue bank 20 includes a first memory portion 30 in the form of a highlight color print queue 32 holding a plurality of highlight color print jobs 34. Similarly, a second memory portion 36 is provided in the form of a monochrome-color print queue 38 for storing exclusively a plurality of monochrome-color print jobs 40. Lastly, a third memory portion 42 is formed in the print queue bank 20 for providing a monochrome-black print queue 44 storing a plurality of monochrome-black (black only) print jobs 46. Although separate memories and print queues are illustrated schematically in the print system 10 of FIG. 1, is to be appreciated that more or less memories or print queues can be used as needed or desired. For example, a single memory with a single print queue storing all of the various print job types, including full color print jobs, can be used as well. In addition, other digital image data formats may become available or used in the future in addition to the highlight color, monochrome color, and monochrome black formats identified above. The method and system of the present application accommodates these formats as well.

As noted above, the present application provides a method and apparatus for detecting and promoting monochrome jobs to be printed by the print engine (IOT) 18 illustrated in FIG. 1. The system finds particular application in printing production sites that are considered “lights out” or that have minimal operator oversight. The job mix in the plurality of print jobs 22 received into the job spooler 14 of the DFE 12 will typically include black and white jobs as well as color print jobs and other data formats identified above and others. The print system 10 can, at times however, reach a state where only monochrome jobs are printable but HLC jobs and/or any other jobs having a color content are unprintable.

Such fault conditions may occur for various reasons such as, for example, when the highlight color toner is low in the highlight color xerographic subsystem 18a of the print engine 18. The monochrome (black) xerographic subsystem is designated as 18b in the figure. In addition, a fault may occur when an incorrect highlight color toner color is loaded in the HLC subsystem 18a. This could result in a mismatch between the highlight color required by the job and desired by the customer and the highlight color available. Still further, a general fault in the HLC xerographic subsystem 18a can interrupt the ability of the system 10 to print color jobs. Other fault conditions localized to the color portion rendering it unusable may occur as well. An operator interface 50 is provided in the DFE 12 in association with the processor 16. The operator interface 50 is adapted to generate an alarm when the IOT 18 is incapable of printing color jobs. The alarm may take on any form and may include a flashing light, an audible alarm, or simply an electronic signal such as transmission of data to an associated network (not shown) which may be supervised by one or more personnel. Preferably, the operator interface 50 includes a physical or logical mode switch 52 for selecting a logical state of the automated promotion of monochrome jobs method when the system 10 is incapable of printing in color because of one or more faults.

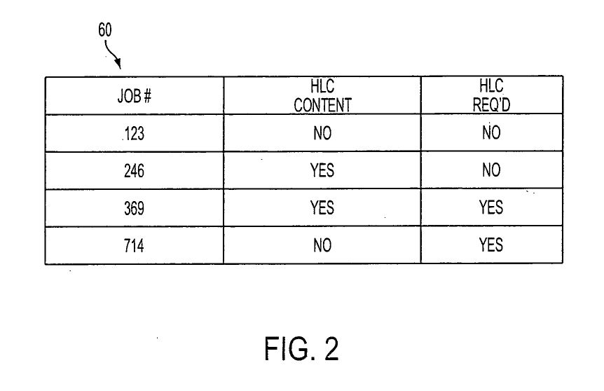

Turning now to FIG. 2, the color print queue within the DFE 12 shown in FIG. 1 is illustrated in greater schematic detail. As shown there, the print queue includes a table 60 storing pointers to print jobs and information regarding the print jobs for inspection and use by the supervisory processor 16. A first column in the table 60 stores information relating a print job name to the plurality of print jobs stored in the memory. A second column in the table 60 includes information on selected details of the print job data, preferably including, for example, information on whether the print job includes a color content. Lastly, a third column in the table 60 includes information relating to selected parameters within which the print jobs are to be output into hard copy format, namely whether highlight color is required per job specification. As an example, some commercial printing operation customers may desire a color content in their documents but may not absolutely require the color content. In those cases, although a job was scheduled or planned using a color content component, it could be printed in black and white mode.

In the example illustrated, print job 123 has no color content, and therefore, highlight color printing is not required. Therefore, job 123 could be printed in the system 10 regardless of the functionality of the color xerographic subsystem 18a of the print engine 18. Also therefore, job 123 is a candidate for automated promotion for printing ahead of jobs having a color content when the color subsystem 18a is unusable.

For job 246 in the print queue table 60 of FIG. 2, color content is present in the document but the customer does not insist upon color in the final product. Essentially, highlight color is optional to this customer. Therefore, job 246, like job 123, is qualified for automated promotion for printing using black or monochrome subsystem 18b when the color subsystem 18a of the print engine is unusable.

Next, job 369 includes a color content and highlight color is required in the final output product. For jobs such as job 369, a malfunction in the color xerographic subsystem 18a would prevent the job from printing. In those situations, the mode switch 52 is inspected by the processor 16 in accordance with the invention in a manner to be described in greater detail below. Essentially, however, monochrome print jobs are promoted for printing in advance of jobs having a color content such as job 369 based on the logical state of the mode switch 52 in accordance with this application. Lastly, job 714 is simply a black and white print job.

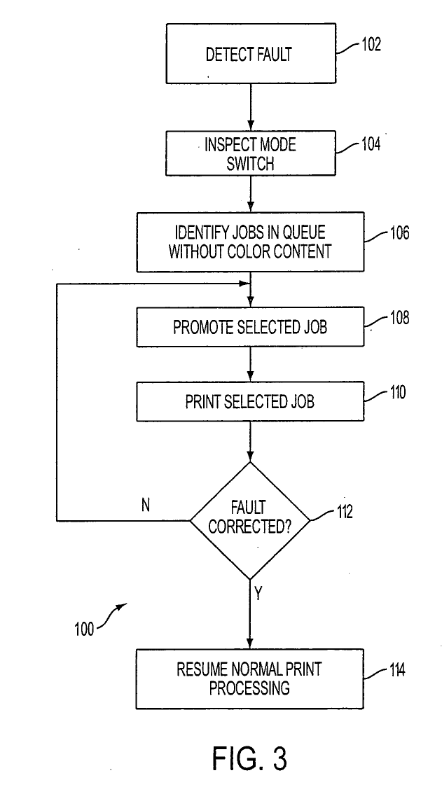

Turning next to FIG. 3, a first technique for automated promotion of monochrome jobs in highlight color production printers is discussed. As shown there, the method 100 includes a first step 102 of detecting a fault in the print engine 18 of the subject print system 10 shown in FIG. 1. In the context of the present application, a fault refers to a state in the printing device where monochrome jobs are printable but HLC jobs and/or other color jobs or jobs having a color content are unprintable. This condition may occur for various reasons including, but not limited to, an inadequate supply of highlight color toner, a mismatch between the toner color loaded in the color subsystem 18a and the color required by the print job, a general electrical or mechanical fault in the color xerographic subsystem, and a wide range of other reasons.

In the prior art as described above, a fault occurring in any portion of the printer caused all print jobs to suspend pending human operator intervention and resolution of the underlying malfunction. In accordance with the present application, however, monochrome jobs are automatically promoted for printing ahead of jobs having color content when the system 10 is unable to print color jobs, based on the detected state of the mode switch 52. To that end, at step 104, the processor 16 interrogates the setting of the mode switch 52 associated with the operator interface 50. When it is determined that the system is in automated promotion mode as determined at step 104, the color print queue is interrogated at step 106 to identify first print jobs in the print queue not having a color content.

In accordance with the present application, preferably, the processor 16 uses a raster image processing (RIP) technique for determining color content in print jobs stored in the print queue bank 20. Essentially, using this technique, the processor uses the RIP in a color space such as, for example, CIELAB to look for pixels to determine if any of the pixels in respective print jobs contain color content. Preferably, the pages are analyzed using the RIP technique performed at low resolution such as, for example, at 100 dpi to CIELAB. The pages are analyzed for color content and, if any a* and/or b* non-zero pixel values are present in the page, the page is designated as a color page/job. Conversely, any pages having a zero a* and b* value for all pixels are characterized as black and white pages/jobs. If all pages within a job are recognized as black and white, the job is eligible for promotion for printing ahead of jobs having a color content. To that end, at step 108, the first job identified in step 106 as having no color content is promoted to the top of the print queue. Then, at step 110, the first black and white job identified is printed. Other techniques may be used as well such as, for example, a direct inspection of the HLC data plane techniques may be used to find pixels having a non-zero value. In RGB color space, the inspection technique looks to find R=G=B.

If the fault in the color xerographic subsystem is detected at step 112 as being resolved, the normal print queue processing is resumed at step 114. However, if it is determined at step 112 that the color subsystem fault has not been corrected, the processor 16 returns to step 106 in accordance with the preferred method 100 to interrogate the color print queue to find a subsequent print job without color content for promotion for printing ahead of jobs having a color content.

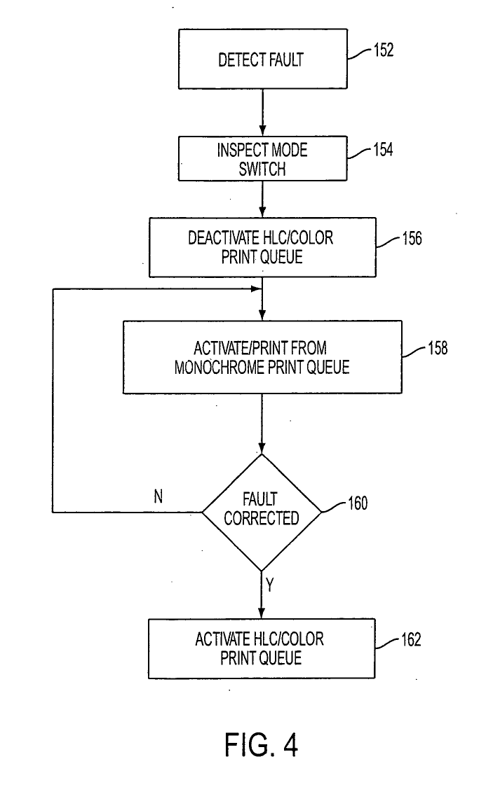

FIG. 4 illustrates another method of promoting monochrome jobs when a fault is detected in a color subsystem. The method 150 of FIG. 4 is applicable to print systems 10 having a separate monochrome print queue 44 adapted to store print jobs 46 without color content. Turning now to that figure, at step 152, a fault is detected in the color subsystem 18a of the print system. At step 154, the state or logical level of mode switch 52 is interrogated in order to determine whether the print system is to promote monochrome jobs ahead of jobs having a color content. At step 156, the highlight color and print queues 32, 38 are deactivated. In that way, the processor 16 will be precluded from forwarding print jobs to the print engine 18 drawn from the highlight color and print queues. Preferably all print queues are deactivated except for the monochrome print queue 44. At step 158, the monochrome print queue 44 is activated so that all print jobs directed to the print engine 18 are drawn exclusively from the monochrome print queue. At step 160, it is determined whether the fault in the color xerographic subsystem has been corrected and, if corrected, the highlight color and color print queues are once again reactivated at step 162. However, if the fault is not determined to be corrected at step 160, print jobs are drawn exclusively from the monochrome print queue 44. Although the preferred method activates only the monochrome print queue 44 and draws print jobs from it exclusively, another equivalent print queue can be similarly utilized for printing black and white jobs ahead of color jobs in a color printing system when the system is unable to print in a desired color.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of print queue management in a highlight color printing apparatus, the method comprising:
storing a plurality of first print jobs having a color content in a print queue of said highlight color printing apparatus;
storing a plurality of second print jobs not having a color content in said print queue of said highlight color printing apparatus;
detecting, in said highlight color printing apparatus, an inability of the printing apparatus to print hard copy documents having a color content; and,
when said inability of the printing apparatus to print said hard copy documents having said color content is detected, selecting for printing from said print queue only from said plurality of second print jobs not having said color content.

2. The method according to claim 1 wherein:
said storing said plurality of first print jobs includes storing each of said print jobs including an electronic image of an original document having a color content; and,
said storing said plurality of second print jobs includes storing each of said second print jobs including an electronic image of a black and white only original document having no color content.

3. The method according to claim 1 wherein said detecting includes detecting a low level of highlight color toner in said highlight color printing apparatus.

4. The method according to claim 1 wherein said detecting includes detecting an incompatible or incorrect highlight color toner loaded in said highlight color printing apparatus.

5. The method according to claim 1 wherein said detecting includes detecting a fault in a highlight color xerographic portion of said printing apparatus.

6. The method according to claim 1 wherein said selecting includes determining a logic level of a system setting in said highlight color printing apparatus for automated promotion of black and white only documents.

7. The method according to claim 1 further including:
displaying by said highlight color printing apparatus, a human readable fault message when said inability of the printing apparatus to print the hard copy documents having the color content is detected.

8. The method according to claim 1 wherein said selecting includes processing said plurality of first and second print jobs to determine a set of print jobs not having a color content.

9. The method according to claim 8 wherein said processing includes performing a raster image processing (RIP) on said plurality of first and second print jobs stored in said print queue.

10. The method according to claim 1 wherein:
said storing plurality of first print jobs includes storing said plurality of first print jobs in a monochrome print queue of said highlight color printing apparatus;
said storing said plurality of second print jobs includes storing said plurality of second print jobs in a color print queue of said highlight color printing apparatus; and,
said selecting includes deactivating said color print queue and activating said monochrome print queue for printing by said highlight color printing apparatus exclusively from said monochrome print queue.

11. The method according to claim 1 further including:
detecting, in said highlight color printing apparatus, a resumed ability of the printing apparatus to print said hard copy documents having said color content; and,
when said resumed ability of the printing apparatus to print said hard copy documents having said color content is detected, resuming selecting for printing from said print queue both of said first print jobs and said second print jobs.

12. A print queue management system in a highlight color printing apparatus, the system comprising:
a print queue storing a plurality of first print jobs having a color content and a plurality of second print jobs not having a color content; and,
a processor adapted to detect in said highlight color printing apparatus, an inability of the printing apparatus to print hard copy documents having a color content and, when said inability of the printing apparatus to print said hard copy documents having said color content is detected, selecting for printing from said print queue only from said plurality of second print jobs not having said color content.

13. The system according to claim 12 wherein said processor is adapted to detect a low level of highlight color toner in said highlight color printing apparatus.

14. The system according to claim 12 wherein said processor is adapted to detect an incompatible or incorrect highlight color toner loaded in said highlight color printing apparatus.

15. The system according to claim 12 wherein said processor is adapted to detect a fault in a highlight color xerographic portion of said printing apparatus.

16. The system according to claim 12 wherein:
said print queue includes a color print queue storing said plurality of first jobs having a color content;
said print queue includes a monochrome print queue storing said plurality of second print jobs not having a color content;
said processor is adapted to deactivate said color print queue and activate said monochrome when said inability of the printing apparatus to print said hard copy documents having said color content is detected.

17. The system according to claim 16 wherein said processor is adapted to detect a resumed ability of the printing apparatus to print said hard copy documents having said color content and reactivate said color print queue for resumed printing of color print jobs.

18. The system according to claim 12 further including a mode switch and wherein said processor is adapted to read a logical level of said mode switch and select for printing only from said plurality of second print jobs not having said color content based on said logical level of said mode switch.

19. A print queue management system in a marking apparatus, the system comprising:
a print queue storing a plurality of first print jobs having a color content and a plurality of second print jobs not having a color content; and,
a processor adapted to detect in said marking apparatus, an inability to print hard copy documents having a color content and, when said inability to print said hard copy documents having said color content is detected, selecting for printing from said print queue only from said plurality of second print jobs not having said color content.

20. The system according to claim 19 wherein said processor is adapted to:
read a logical level of a mode switch and select for printing only from said plurality of second print jobs not having said color content based on said logical level of said mode switch; and,
detect a resumed ability of the marking apparatus to print said hard copy documents having said color content and reactivate said color print queue for resumed printing of color print jobs.
